(19) United States
(12) Patent Application Publication
(10) Pub. No.: US 2007/0053823 A1
(43) Pub. Date: Mar. 8, 2007

(54) Technique of production of fancy red diamonds

(76) Inventor: Viktos Genrihovich Vins, Novosibirsk (RU)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 10/562,328

(22) PCT Filed: May 27, 2004
(86) PCT No.: PCT/RU04/00205

§ 371 Date: May 18, 2006

(30) Foreign Application Priority Data
Jun. 26, 2003 (RU) 20032119470

(51) Int. Cl. B01J 3/06

(52) U.S. Cl. 423/446; 423/264

(57) ABSTRACT

The invention relates to the treatment (enhancement) of diamonds in order to give them different colors and can be used by the gem and jewelry trade. The technique consists in producing isolated substitutional nitrogen atoms, or C centers, in the crystal lattice of natural near-colorless-to-brown type Ia diamonds containing A centers or in the crystal lattice of natural near-colorless high-nitrogenous type Ia diamonds containing over 800 ppm of nitrogen in the form of A and B1 centers. Natural type Ia diamonds containing A centers are HPHT-treated in a high-pressure apparatus at a temperature exceeding 2150° C. and under a stabilizing pressure of 6.0-7.0 GPa. Then they are irradiated with 5·10¹⁵-5·10¹⁸ cm⁻² 2-4 MeV electrons and finally annealed in a vacuum at a temperature exceeding 1100° C. Natural high-nitrogenous type Ia diamonds containing over 800 ppm of nitrogen in the form of A and B1 centers are irradiated with high-energy electrons with the irradiation dose over 10¹⁹ cm⁻² and annealed in a vacuum at a temperature exceeding 1100° C. In this manner natural red diamonds with stable NV centers absorbing in the 400-to-640 nm range are produced.

### FIELD OF THE INVENTION

The invention relates to diamond enhancement in order to give diamonds different colors, in particular, a unique red color, which can be used by the gem and jewelry trade.

### BACKGROUND INFORMATION AND PRIOR ART

There exists a technique of production of red-yellow and black diamonds. It is based on the color superposition principle, i.e. the required color is obtained when a natural color of a diamond is mixed with an “artificial” color produced with 5·10¹⁵-5·10¹⁸ cm⁻² electron irradiation and annealing at 300-to-1900° C. for a period of time ranging from 30 min to several hours at a room pressure or in an ultrahigh vacuum or with a pulse heating. The whole process is repeated several times to get the required coloration (RU 2145365 C1, 10.02.2000).

The commonly accepted modern physical classification of diamond types has been described in numerous papers (see, for example Walker John, Optical absorption and luminescence in diamond—Reports on Progress Physics, 1979, v.42). It divides diamonds into four types:
Type IIa are diamonds with low nitrogen content. The main classifying properties are: no absorption in the IR region, a pronounced fundamental absorption edge at 225 nm in the UV region. These diamonds are rare, they do not exceed 2% of all mined natural diamonds;
Type IIb are blue semi-conducting diamonds. They contain less nitrogen than type IIa diamonds. Blue color and semi-conductor properties are due to a boron impurity which enters the lattice in the form of isolated substitutional atoms;
Type Ia are the most wide-spread natural diamonds (up to 98%) containing up to 0.3 atomic % of nitrogen, The most common nitrogen impurity forms are A centers (nitrogen pairs in the neighboring lattice sites) and B1 centers (four nitrogen atoms surrounding a vacancy);
Type Ib are the rarest natural diamonds (less than 0.2%) and most common synthetic diamonds. They contain up to 0.05 atomic % (approximately 5-6 ppm) of isolated substitutional nitrogen atoms (C centers). The absorption band attributed to C centers begins in the visible region, at about 500 nm, increases towards short wavelengths and causes yellow coloration of type Ib diamonds.

It is known that in order to make a natural red diamond, diamonds are sorted out by means of optical spectroscopy to find diamonds that contain some of the impurity nitrogen in the form of isolated substitutional atoms (C centers). According to the physical classification such diamonds can be either type Ib or mixed types Ia+Ib or Ib+Ia. The work (Collins A. T Migration of nitrogen in electron irradiated type Ib diamond—J Phys. C: Solid State Phys., 1978, v.11, 10, L417-L422) described the fundamental processes of defect transformation in the crystal lattice of type Ib diamonds that take place after high energy electron irradiation (10²² m⁻² 2 MeV) and subsequent annealing in a vacuum (800° C., 2 hrs). After the electron irradiation there appear a great number of primary radiation defects: vacancies and self-interstitials. The subsequent annealing in a vacuum allows stable NV color centers to be obtained. NV centers are isolated substitutional nitrogen atoms and vacancies in the neighboring lattice sites. Such defects absorb in the red spectral region at wavelengths less than 640 nm (1.945 eV) and they are responsible for a red diamond color.

There exists a technique of production of a purple diamond from a synthetic diamond (U.S. Pat. No. 4,950,463 A, 21, Aug. 1990). According to this technique a synthetic type Ib diamond containing nitrogen in the form of C centers within the range from 8·10¹⁷ to 1.4·10¹⁹ at/cm³ (or from 4.5 to 80 ppm) is irradiated with 5·10¹⁶-2·10¹⁸ cm⁻² 2-4 MeV electrons and subsequently annealed in a vacuum under a pressure exceeding 10-2 Torr and at a temperature ranging from 800 to 1100° C. for over 20 hours. A purple diamond with NV color centers absorbing within the 500-to-640 nm range with a peak at 570 nm is produced.

However, it was determined from the analysis of luminescence excitation spectra in the paper by V. G. Vins (Spectroscopy of optically active defects in synthetic diamond—Avtoref.dis.kand.phys.-mat.nauk, Minsk, 1989, 21 pp.) that NV centers absorbed within the 400-to-640 range. In type Ib diamonds the absorption due to NV centers is superimposed on the absorption due to C centers which begins and increases at wavelengths less than 500 nm. Thus, the sum absorption spectrum of a type Ib diamond containing NV centers covers the 400-to 640 nm range.

### DETAILED DESCRIPTION OF THE INVENTION

The main task of the invention is to develop such a technique of production of red diamonds that could form stable NV color centers, which absorb in the red spectral range from 400 to 640 nm, in the crystal lattice of natural type Ia diamonds.

For that natural type Ia diamonds are used and in their crystal lattice isolated substitutional nitrogen atoms (C centers) are formed. Then the diamonds are irradiated with fast electrons and annealed in a vacuum at high temperatures.

It should be noted that natural type Ia diamonds should contain nitrogen impurity in the form of A centers or natural diamonds should be high-nitrogenous and contain nitrogen in the form of A and B1 centers with a concentration exceeding 800 ppm.

Natural near-colorless-to-brown type Ia diamonds containing nitrogen in the form of A centers are previously annealed in a high-pressure apparatus at a temperature exceeding 2150° C. and under a stabilizing pressure of 6.0-7.0 GPa (the so-called HPHT-treatment). After that they are irradiated with high-energy electrons with a dose ranging from 5·10¹⁵ to 5·10¹⁸ cm⁻² (preferably 10 cm⁻²) at 2-4 MeV and annealed in a vacuum at a temperature exceeding 1100° C.

Natural near-colorless high-nitrogenous type Ia diamonds containing nitrogen in the form of A and B1 centers with the concentration over 800 ppm are irradiated with high energy particles, for instance electrons, with a dose exceeding 10¹⁹ cm⁻² and annealed in a vacuum at a temperature exceeding 1100° C.

Our experimental data show that during HPHT treatment of natural type Ia diamonds containing A form of nitrogen (nitrogen pair in the neighboring sites) at a temperature exceeding 2150° C. from 15 to 20% of A centers dissociate, while other defects including C centers are produced, the concentration of the latter being no less than 10 ppm.

It was shown in an earlier research by V. G. Vins (Changing color of natural brown diamonds by HPHT-processing, Proceedings of All-Russian Mineralogical Society, 2002, 4, pp. 112-119) that no dissociation of A centers and consequently formation of C centers occurred in natural diamonds HPHT-treated at lower temperatures (lower than 2150° C.). The concentration of C centers that formed following HPHT treatment at a temperature exceeding 2150° C. is sufficient for stable NV centers to form after the subsequent electron irradiation and high temperature annealing in a vacuum. NV centers absorb in the red region of the spectrum (400-640 nm) imparting the diamond different hues of red.

The mechanism of formation of C centers when natural high-nitrogenous type Ia diamonds containing over 800 ppm of nitrogen in the A form (nitrogen pair in neighboring sites) and B1 form (four nitrogen atoms surrounding a vacancy) are irradiated with high energy particles (e.g. electrons) is described below. Nitrogen atoms from A and B1 centers are displaced into interstitial position. On the subsequent annealing interstitial nitrogen atoms annihilate with vacancies to form isolated substitutional nitrogen atoms, i.e. C centers. Also, an absorption in a narrow line at 1346 cm⁻¹ due to C centers was observed. That is, along with interstitial nitrogen atoms isolated substitutional nitrogen atoms (C centers) appear in the crystal lattice. The concentration of C centers reaches 5 ppm. Then the vacancies get trapped at the newly formed C centers to form stable NV color centers that absorb in the red spectral region at wavelengths not exceeding 640 nm and cause red diamond color of different hues.

All changes in the set and concentration of optically active defects, such as A, B1, C, N3, H3 and NV, in the diamond crystal lattice were determined from the absorption intensity of the corresponding bands in the IR-vis-UV spectral range.

Below are the examples of production of fancy red diamonds with stable NV color centers absorbing within the 400-to-640 nm range.

### EXAMPLE 1

A natural brown diamond weighing 1.84 carats was used. The diamond initially contained 92 ppm of impurity nitrogen in the A form and 258 ppm of impurity nitrogen in the B1 form. The IR absorption spectra also revealed the 1370 and 1430 cm⁻¹ bands attributed to platelets and a narrow line at 3107 cm⁻¹ attributed to hydrogen impurity defects. In the visible region at wavelengths less than 650 nm continuous absorption increased towards shorter wavelengths. Weak absorption bands at 415 and 503 nm attributed to N3 and H3, respectively, were observed in said diamond. Judging by its absorption spectra and set of impurity defects the diamond unambiguously belonged to type Ia. The diamond was HPHT-treated in a high-pressure apparatus at 2150° C., 7 GPa for 10 minutes. Following HPHT treatment the concentration of A centers decreased to 71 ppm, B1 center concentration remaining on the same level. About 20 ppm of C centers were formed. The absorption intensity due to platelets decreased three times. No hydrogen-related absorption was observed following HPHT-treatment. In the visible spectrum an absorption increase at wavelengths less than 550 nm was seen. The transmission edge was at 423 nm. Absorption bands at 503 nm (very weak) and 990 nm in the near-IR region were seen. The color of the diamond after HPHT treatment became greenish-yellow. According to its defects the diamond was graded as a mixed type Ia+Ib.

After that the diamond was irradiated with 1018 cm⁻² 3.0 MeV electrons. Such irradiation parameters created about 10 ppm of vacancies in the crystal lattice, which was in agreement with the data obtained from synthetic diamond irradiation and referred to in the work by V. G. Vins (Changing color of synthetic diamonds by means of electron irradiation and subsequent annealing, Gemmological Bulletin, 2002, 2(5), pp. 19-33). Following the irradiation the color of the diamond was opaque dark green. Then the diamond was placed in a vacuum-processed quartz ampoule and annealed at 1100° C. for 24 hours. In the course of annealing the vacancies migrated and got trapped at isolated nitrogen atoms, which resulted in the formation of 1.5 to 2 ppm of stable NV color centers. The NV-related absorption observed at wavelengths less than 640 nm with a peak at 570 nm was superimposed on the initial absorption (before electron irradiation and subsequent annealing) with the transmission edge at 423 nm, which caused the final diamond color. The color was graded as Fancy Intense Purple-Red.

### EXAMPLE 2

A natural near-colorless diamond weighing 2.948 carats and containing A centers with such a concentration that it did not allow IR absorption spectra to be recorded. A 0.236 carat piece was sawn from the diamond and then two parallel-sided plates, 0.2 and 0.3 mm, were made from the piece. The concentration of A centers in both plates was about 800 ppm. IR spectra revealed one absorption system with the strongest band at 1282 cm⁻¹, which is typical of type Ia diamonds containing A centers. The absorption edge was at 300 nm in the UV region. No absorption was seen in the visible region. Both plates were irradiated with 10¹⁹ cm⁻² 3.0 MeV electrons. Following the irradiation both plates turned opaque black. After the irradiation the plates were annealed in a vacuum-processed quartz ampoule at about 1100° C. for 24 hours. The annealing restored transparency of both plates and changed their color to purple-red.

Along with the absorption system associated with A centers, the 1450 cm⁻¹ absorption band was seen in the IR spectra. This band is attributed to single interstitial nitrogen atoms and had also been observed in synthetic diamonds (Malogolovetz V. G. The study of impurities and genuine structure of synthetic diamonds using spectroscopic methods. Avtoref. dis. kand. phys.-mat.nauk, Kiev, 1979, 21 c) Also a narrow absorption line at 1346 cm⁻¹ due to C centers was observed. That means that along with interstitial nitrogen atoms there appeared isolated substitutional nitrogen atoms (C centers). C center concentration was about 5 ppm and an intensive absorption band at 640 nm was seen in the visible spectrum, which is indicative of NV center formation.

After the color of both plates had been changed we applied the same technique to the remaining large piece (2.712 carats). It also changed its transparent color to intense purple-red.

Thus, the proposed technique can be used to produce gem-quality red diamonds. It can be used to treat (enhance color) of all natural type Ia diamonds that initially do not have nitrogen impurity in the form of C centers, but have any concentrations of nitrogen in the form of A and B1 centers.

1. A diamond, comprising a natural red type Ia diamond with stable NV color centers absorbing in the 400-to-640 nm range and imparting a red color to said diamond, said diamond being produced from the following:
(a) a natural near-colorless-to-brown type Ia diamond containing A centers by means of HPHT-treating said diamond in a high-pressure apparatus at a temperature exceeding 2150° C. and under a stabilizing pressure of 6.0-7.0 GPa, irradiating said diamond with 5·10¹⁵-5·10¹⁸ cm⁻² 2-4 MeV electrons and finally annealing said diamond in a vacuum at a temperature exceeding 1100° C.
(b) a natural near-colorless high-nitrogenous type Ia diamond containing over 800 ppm of nitrogen in the form of A and B1 centers by means of irradiating said diamond with high-energy electrons with the irradiation dose over 10¹⁹ cm² and annealing said diamond at a temperature exceeding 1100° C.

2. A technique of producing a diamond of claim 1, comprising the steps of:
(a) using a natural near-colorless-to-brown type Ia diamond containing A centers,
(b) subjecting said diamond to HPHT-treatment in a high-pressure apparatus at a temperature exceeding 2150° C. and under a stabilizing pressure of 6.0-7.0 GPa, to cause A center dissociation and C center formation in said diamond,
(c) irradiating said diamond with 5·10¹⁵-5·10¹⁸ cm⁻² 2-4 MeV electrons to produce a large number of vacancies in said diamond,
(d) annealing said diamond in a vacuum at a temperature exceeding 1100° C., at which vacancies migrate and get trapped at C centers to form stable NV color centers, whereby said diamond has stable NV centers absorbing in the 400-to-640 nm range and imparting a red color to said diamond.

3. A technique of producing a diamond of claim 1, comprising the steps of:
(a) using a natural near-colorless high-nitrogenous type Ia diamond containing over 800 ppm of nitrogen in the form of A and B1 centers,
(b) irradiating said diamond with high-energy electrons with the irradiation dose over 10¹⁹ cm⁻² to produce interstitial nitrogen atoms and vacancies in said diamond,
(c) annealing said diamond at a temperature exceeding 1100° C., at which interstitial nitrogen atoms annihilate with vacancies to form C centers and then the newly formed C centers capture more vacancies to form stable NV color centers, whereby said diamond has stable NV centers absorbing in the 400-to-640 nm range and imparting a red color to said diamond.
